(19) United States
(12) Patent Application Publication
(10) Pub. No.: US 2008/0016116 A1
(43) Pub. Date: Jan. 17, 2008

(54) Online systems, methods, and interfaces for providing pharmaceutical information

(76) Inventor: Ian Tarr, London (GB)

Correspondence Address: SCHWEGMAN, LUNDBERG & WOESSNER, P.A., P.O. BOX 2938, MINNEAPOLIS, MN, 55402, US

(21) Appl. No.: 11/649,349

(22) Filed: Jan. 3, 2007

Related U.S. Application Data
(60) Provisional application No. 60/755,021, filed on Dec. 30, 2005.

(51) Int. Cl. G06F 17/30; G06F 15/16

(52) U.S. Cl. 707/104.1; 709/203; 707/E17.009

(57) ABSTRACT

An online pharmaceutical research system includes a server for providing user-configurable home pages, with each home page having a set of two or more portlets for different types of pharmaceutical data. The home page includes therapeutic filtration technology that enables the user to filter two or more of the portlets based, for example, on a therapeutic category.

### RELATED APPLICATION

This application claims priority to U.S. provisional patent application 60/755,021, which was filed on Dec. 30, 2005. This application is incorporated herein by reference.

### COPYRIGHT NOTICE AND PERMISSION

One or more portions of this patent document contain material subject to copyright protection. The copyright owner has no objection to the facsimile reproduction by anyone of the patent document or the patent disclosure, as it appears in the Patent and Trademark Office patent files or records, but otherwise reserves all copyrights whatsoever. The following notice applies to this document: Copyright © 2005, Thomson Scientific.

### TECHNICAL FIELD

The present invention concerns pharmaceutical product development, particularly information retrieval systems, methods, and software that facilitates the work of pharmaceutical researchers.

### BACKGROUND

Over the last half century, the pharmaceutical industry has developed a variety of medicines that have had an enormous impact on the quality of life and wellbeing of millions of people. Researchers in the industry share and insights data with one another, frequently accessing research papers, patents, and other important information via the internet using public and/or private information retrieval services.

One problem that the present inventor recognized with conventional online pharmaceutical research services concerns accessibility and management of the information provided by these services. Specifically, many services provide their unique user interfaces for defining queries, reviewing search results, and providing related functionality. This diversity, or lack of standardization, requires users of multiple services not only to learn different interfaces, query languages, and so forth, but also to maintain separate accounts, passwords, and so forth.

Thus, for example, a user interested in searching patents and scientific papers and financial news is generally compelled to use three separate search services, defining and submitting three separate queries in three separate interfaces, reviewing documents in three separate results lists. Moreover, any relevant results are spread across the three services, leaving the user to manually gather and organize the results into a central and convenient form. Furthermore, one or more of the services may provide some automatic or semi-automatic process for obtaining new or updated information. However, the update processes are completely separate and distinct from each other, further compounding the problem of conveniently and intelligently aggregating the data.

Accordingly, the present inventor identified a need to provide better ways of conducting pharmaceutical research across disparate informational resources.

### SUMMARY

To address this and/or other needs, the present inventor devised, among other things, information retrieval systems, methods, and software that allow users to define and selectively display two or more pharmaceutical research webpages comprising multiple simultaneously displayed portlets that incorporate information from separate databases, such as patent, scientific, and financial databases. Additionally, the system allows users to separately configure each of the portlets to provide updated information and to simultaneously define an input or presentation filter for two or more of the portlets based on therapeutic criteria.

The exemplary embodiment, includes an online website or portal for providing a multiplicity of web services in the form of portlets. Each web service provides a different content type that a particular type of knowledge worker in the pharmaceutical community can use in a daily workflow. Each portlet pushes current, new or general knowledge out to the user (either in a custom or standardized format) and then offers a number of search applications directed to the various types of uses.

One type of search functionality is referred to as a guided search. This is a preset search in a simple search format, which allows a casual researcher to execute well formed queries with only a few keystrokes. Another embodiment offers visualization of chemical formulae with various graphical or diagrammatic search tools. Some embodiments encompass: iterative or semantic services that learn a particular user's research style, and/or automatically expand search queries from the guided search concept; expansion of content draws and automatic suggestion of new content related to current and past queries, supplementation of past search results with supporting or conflicting research, and highlighting or flagging of conflicting or complementary research lines; implement a push concepts pursuant to the functionality; annotation of spaces intra organizations/lab e-notebooks; establishment of secure, anonymous, or social communal collaborative spaces for the various types of users in the pharmaceutical industry.

### BRIEF DESCRIPTION OF THE DRAWINGS

FIG. 1 is a block diagram of an online pharmaceutical research system 100 corresponding to one or more embodiments of the present invention.

FIGS. 2-11 are facsimiles of various graphical user interfaces in the form of web pages and/or portlets employed within system and corresponding to one or more embodiments of the present invention.

FIG. 12 is a flow chart of an exemplary method of operating system 100 which corresponds to one or more embodiments of the invention.

### DETAILED DESCRIPTION OF EXEMPLARY EMBODIMENT(S)

This document, which incorporates the above-identified Figures as well as the appended claims, describes one or more specific embodiments of an invention. These embodiments, offered not to limit but only to exemplify and teach the invention, are shown and described in sufficient detail to enable those skilled in the art to implement or practice the invention. Thus, where appropriate to avoid obscuring the invention, the description may omit certain information known to those of skill in the art.

### Exemplary Information-Retrieval System

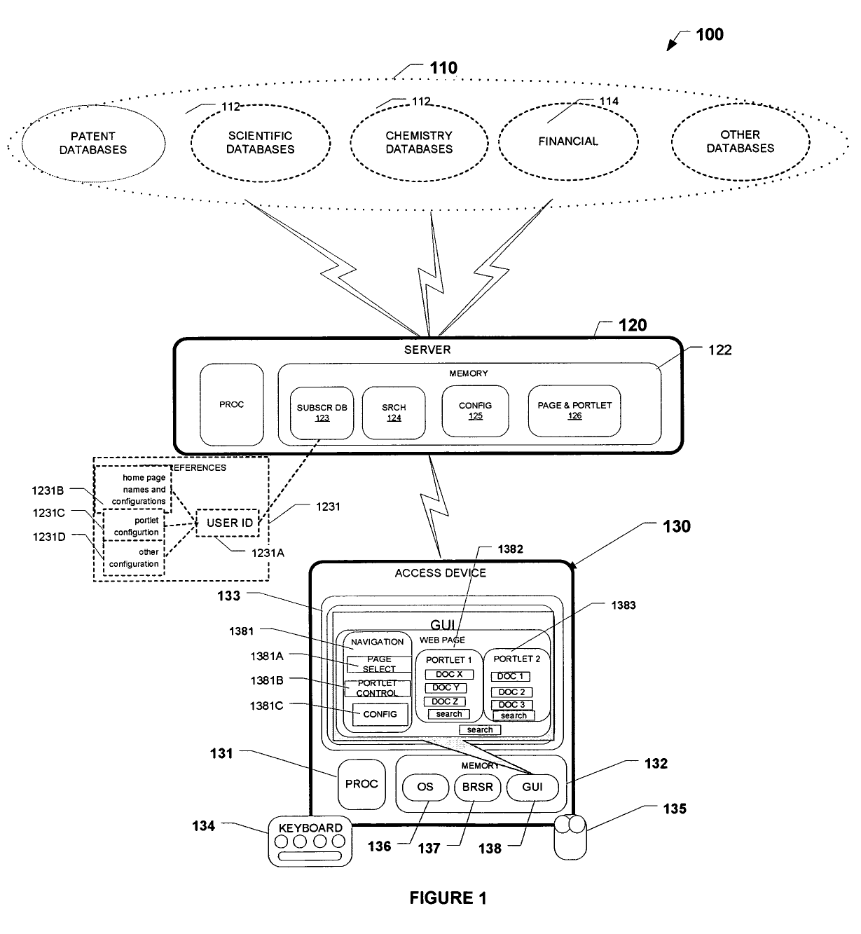

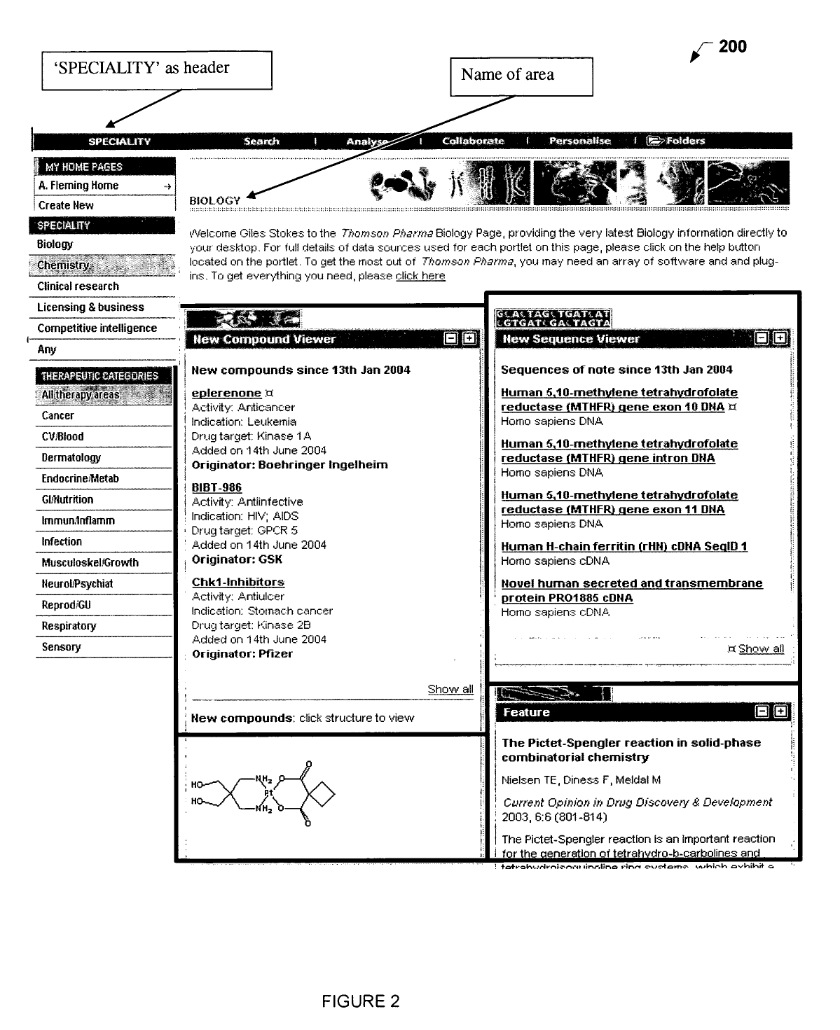

FIG. 1 shows an exemplary online information-retrieval system 100, which may be adapted to incorporate the functionalities and/or capabilities described herein. System 100 includes one or more databases 110, one or more servers 120, and one or more access devices 130.

Databases 110 includes a set of one or more patent databases 111, a set of one or more scientific literature databases 112, a set of financial databases 113, a set of chemistry databases 114, a set of genetic or biological databases 115, and a set of news databases 116, and a set of other databases 117. Databases 110 may also encompass other types of databases and/or data that are implied or explicitly referenced herein. Databases 110, which take the exemplary form of one or more electronic, magnetic, or optical data-storage devices, include or are otherwise associated with respective indices (not shown). Each of the indices includes terms and phrases in association with corresponding document addresses, identifiers, and other conventional information. Data within the databases indexed conventionally as well as by therapeutic categories, such as Cancer, CV/Blood, Dermatology, Endocrine/Metab, GI/Nutrition, Inmun/Inflamm, Infection, Musculoskel/Growth, Neurol/Psychiat, Reprod/GU, Respiratory, Sensory. Databases 110 are coupled or couplable via a wireless or wireline communications network, such as a local-, wide-, private-, or virtual-private network, to server 120.

Server 120, which is generally representative of one or more servers for serving data in the form of webpages or other markup language forms with associated applets, ActiveX controls, remote-invocation objects, or other related software and data structures to service clients of various “thicknesses.” More particularly, server 120 includes a processor module 121, a memory module 122, a subscriber database 123, a primary search module 124, secondary search module 125, and a user-interface module 126.

Processor module 121 includes one or more local or distributed processors, controllers, or virtual machines. In the exemplary embodiment, processor module 121 assumes any convenient or desirable form.

Memory module 122, which takes the exemplary form of one or more electronic, magnetic, or optical data-storage devices, stores subscriber database 123, search modules 124, configuration module 125, and page and portlet management module 126.

Subscriber database 123 includes subscriber-related data for controlling, administering, and managing pay-as-you-go or subscription-based access of databases 110. In the exemplary embodiment, subscriber database 123 includes one or more preference data structures, of which data structure 1231 is representative. Data structure 1221 includes a customer or user identifier portion 1231A, which is logically associated with one or more page and portlet configuration preferences, such as preferences 1231B, 1231C, and 1231D. Preference 1231B includes user home page names and corresponding configurations or definitions. For example, in the exemplary embodiment, the user may define one, two, or more specific home pages, with each page including user portlet selections from a set of available content-specific portlets. Preference 1231C includes portlet configuration data for each of a set of two or more content-specific portlets. The exemplary portlet configuration data, defined more fully below, defines portlet-related parameters, such as update frequency. Preference 1231D includes other configuration data, for example, data affecting or controlling placement of the portlets.

Search module 124 includes machine readable and/or executable instruction sets for one or more search engines and related user-interface components for receiving and processing user queries against one or more of databases 110 as necessary or desirable to provide the home pages and portlets specified content. In the exemplary embodiment, one or more search engines associated with search module 124 provide Boolean, tf-idf, natural-language search capabilities.

Configuration module 125 includes machine readable and/or executable instruction sets for one or more graphical user interfaces and other support software for enabling a user to configure and reconfigure separate home pages and/or their constituent portlets.

Page and portlet module 126 includes machine readable and/or executable instruction sets for wholly or partly defining web-based user interfaces, such as one or more home pages. In the exemplary embodiment, each home page includes two or more portlets and each portlet provides a different content type and/or search interface over a wireless or wireline communications network to an access device, such as access device 130.

Access device 130 is generally representative of one or more access devices. In the exemplary embodiment, access device 130 takes the form of a personal computer, workstation, personal digital assistant, mobile telephone, or any other device capable of providing an effective user interface with a server or database. Specifically, access device 130 includes a processor module 13 lone or more processors (or processing circuits) 131, a memory 132, a display 133, a keyboard 134, and a graphical pointer or selector 135.

Processor module 131 includes one or more processors, processing circuits, or controllers. In the exemplary embodiment, processor module 131 takes any convenient or desirable form. Coupled to processor module 131 is memory 132.

Memory 132 stores code (machine-readable or executable instructions) for an operating system 136, a browser 137, and a graphical user interface (GUI) 138. In the exemplary embodiment, operating system 136 takes the form of a version of the Microsoft Windows operating system, and browser 137 takes the form of a version of Microsoft Internet Explorer. Operating system 136 and browser 137 not only receive inputs from keyboard 134 and selector 135, but also support rendering of GUI 138 on display 133. Upon rendering, GUI 138 presents data in association with one or more interactive control features (or user-interface elements).

In the exemplary embodiment, each of these control features takes the form of a hyperlink or other browser-compatible command input, and provides access to and control of a pharmaceutical research home page having a navigation or page control region 1381 and portlet regions 1382 and 1383. (Although FIG. 1 shows region 1381, 1382, and 1383 as being simultaneously displayed, some embodiments present them at separate times.) Navigation region 1381 includes a page select feature 1381A, a portlet control or filter feature 1381B, and a page configuration feature 1381C.

In the exemplary embodiment, page select feature 1381A allows a user to select from a list of predefined home pages, with each home page having two or more portlets. One or more of the predefined home pages are user-defined home pages based on configuration data for a user in subscriber database 123.

Portlet control feature 1381B allows a user to simultaneously control as aspect of portlet regions 138. For example, in one embodiment, the control feature filters the content based on assigned therapeutic category, such as Cancer, CV/Blood, Dermatology, Endocrine/Metab, GI/Nutrition, Immun/Inflamm, Infection, Musculoskel/Growth, Neurol/Psychiat, Reprod/GU, Respiratory, Sensory. The filter select feature can be implemented using a pull-down menu or set of radio buttons or check boxes. When a therapeutic category is selected, a pop-up is displayed indicating which portlets are filtered. In some embodiment, the pop-up allows the user to select which of the eligible portlets to filter or not filter. On clicking ‘OK’, the pop-up closes and the home page is refreshed with all the appropriate portlets filtered by that category. The last Therapeutic Category remains selected in the exemplary embodiment, so that if the user now selects another specialty page, that page is filtered by that last selected category. The button for the selected category in the left margin is highlighted to remind the user of the filtration operation. In some embodiments, the filtration is only active for the current home or specialty page, such that selecting another page would not automatically result in filtration with the last selected filter variable.

Filtering by the IDdb indication is either directly or ‘implied’ depending on the content of the portlet. So for portlets containing Drug reports, use the IDdb indication terms (therapy areas) applied to the report. For portlets containing news items (i.e. IDdb Alerts), the exemplary embodiment uses the IDdb indications for the drugs or patents linked to the news items. Additionally, the ‘Focused journals’ has been directly indexed. The exemplary embodiment provides the following portlets which can be filtered by a therapeutic category: Clinical Trials Watch; Collaborations/M&A; Drug Phase Changes; Focussed Journals; Licensing Opportunities; New Compound Viewer; New Drugs. The table below shows a set of six home or specialty pages and the portlets that define them.

| | SPECIALTY PAGE (ACROSS) | | | | | |
|---|---|---|---|---|---|---|
| | | | | Licensing | | |
| | | | Clinical | & | | General |
| PORTLET (DOWN) | Biology | Chemistry | Research | Business | CI | interest |
| New Compound | ✓ | ✓ | | ✓ | ✓ | |
| Viewer | | | | | | |
| Drugs | ✓ | ✓ | | ✓ | ✓ | ✓ |
| Thomson selected | ✓ | ✓ | ✓ | ✓ | ✓ | ✓ |
| Features | | | | | | |
| Focused journals | ✓ | ✓ | | | ✓ | ✓ |
| Synthetic methods | | ✓ | | | | |
| Quick Structure | | ✓ | | | | |
| Search | | | | | | |
| New sequences & | ✓ | | | | | |
| targets | | | | | | |
| News headlines | ✓ | | ✓ | ✓ | ✓ | ✓ |
| Conferences and | ✓ | ✓ | ✓ | | | ✓ |
| other meetings | | | | | | |
| Licensing | | | | ✓ | ✓ | |
| opportunities | | | | | | |
| Collaborations/M&A | | | | ✓ | ✓ | ✓ |
| Drug phase changes | | | ✓ | ✓ | ✓ | |
| Clinical trials watch | | | ✓ | ✓ | ✓ | |
| Financial update | | | | ✓ | ✓ | ✓ |
| Patent landscape | | | | ✓ | ✓ | |
| Patents gazette | ✓ | ✓ | ✓ | | | |
| Breaking news* | ✓ | ✓ | ✓ | ✓ | ✓ | ✓ |

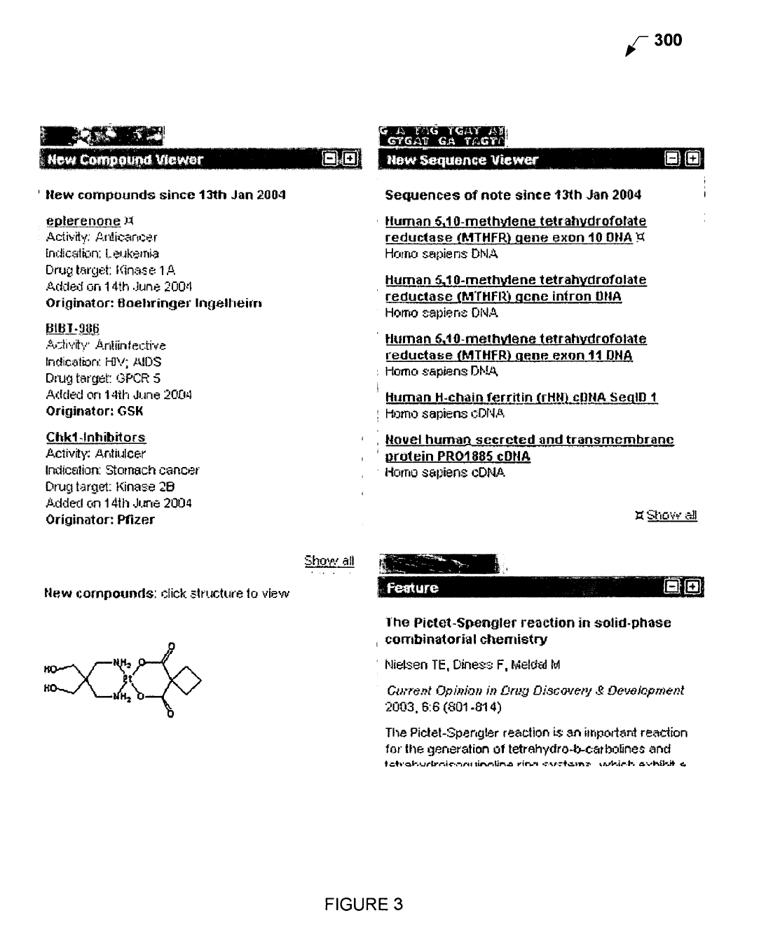

FIG. 3 shows a portion of an exemplary home page 300 that includes three portlets: a new compound view portlet, a new sequence viewer portlet, and feature portlet.

Some portlets have multiple sections or multiple dropdown options, e.g. the new drugs portlet has the section New Drugs and Newly updated drugs. For each section the term “no results found” is given, if appropriate. The mock-up below shows an example for the new compound viewer. This portlet has two sections and the mock-up below indicates that no results have been found for either section.

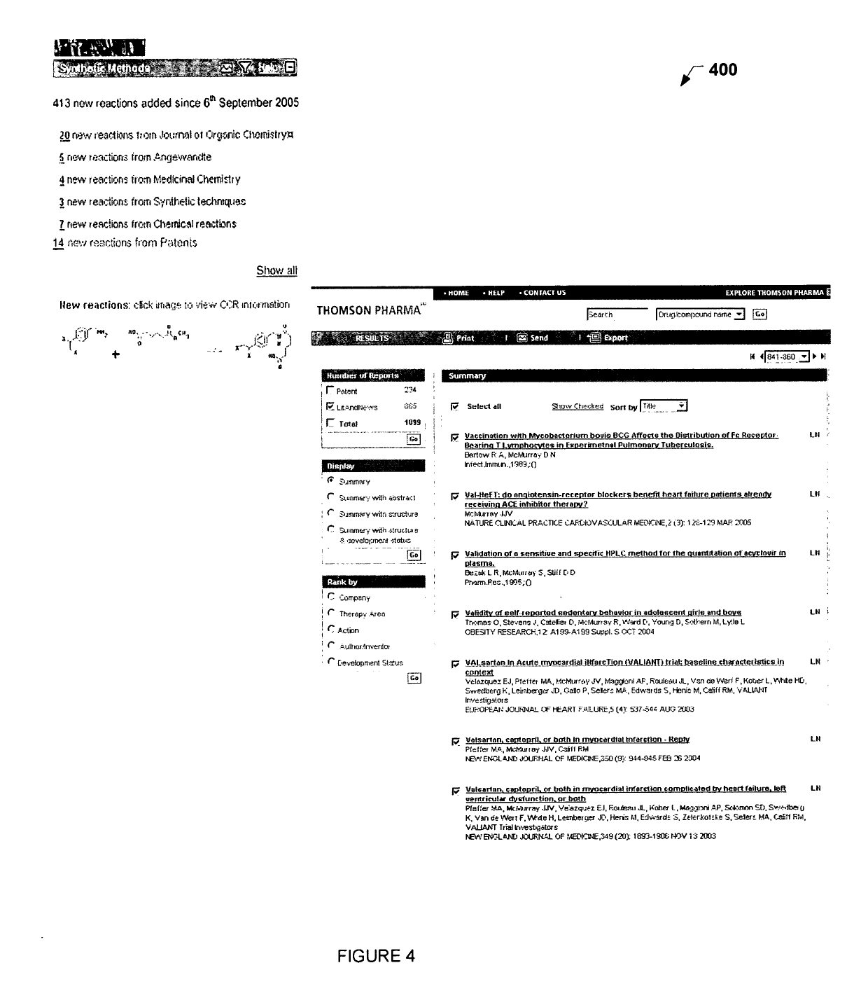

FIG. 4 shows an exemplary synthetic methods portlet which can be used to alert users to new journals containing interesting reaction data. The list of journals is predefined and all Current Chemical Reactions (CCR) records for these journals are selected. The reaction step images from any selected article will scroll from left to right in the portlet. Links from the numbers take users to a Results Summary Page. Links from the scrolling reaction will take the user to full report. By linking to CCR information through this portlet, compounds within Index Chemicus are provided. This portlet will therefore enable the user not only to view reaction data, but also specific compounds involved in the reaction. Index Chemicus is integrated into the T-Pharma compound repository, which is included within databases 110. Therefore by viewing these compounds through the Synthetic Methods portlet, users will then be able to link to other content related to a specific compound, via the Chemistry Report (not shown.)

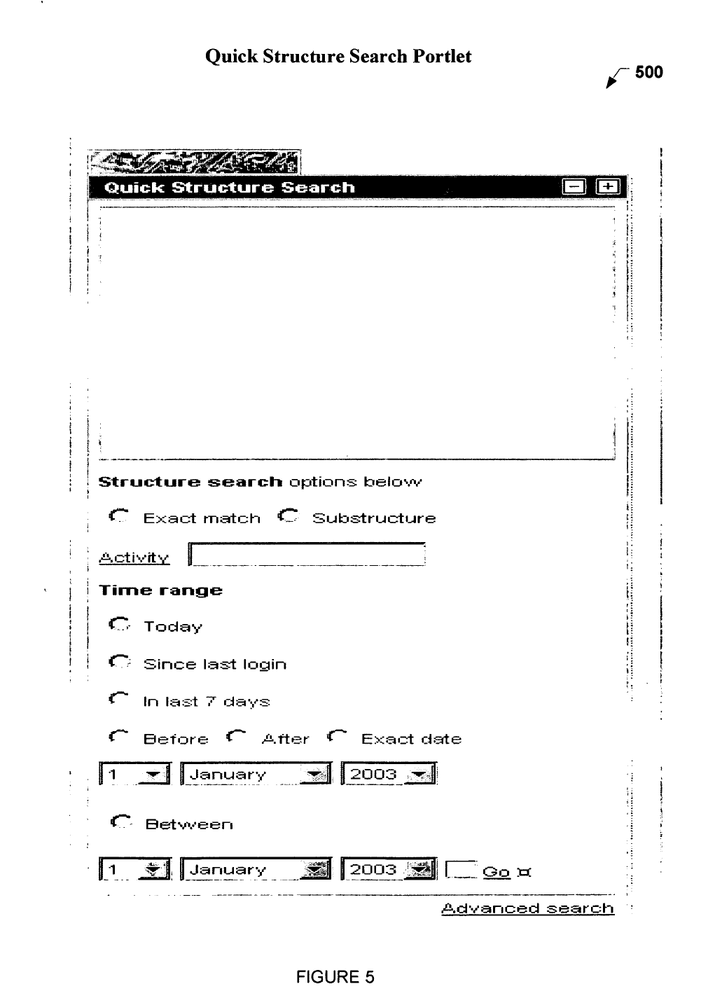

FIG. 5 shows an exemplary Quick Structure Search portlet which allows the user to perform an exact search or substructure search over a time period defined by the user which yields chemistry reports only. In some embodiment, other types of results are allowed. The exemplary search is executed against Pharmaceutical Compound Registry. The content of this portlet does not change according to line of business or therapeutic area. A double click anywhere on the structure box will open a Chemical Drawing package (e.g. ISIS Draw) or will enable the user to import a pre-drawn structure. The “Activity” link takes users to the Actions thesaurus. The exemplary embodiment uses same activity term picker as used in Drug form search page. Because index term mapping is completed for IDDB to DDF to PP to DWPI Section B activity manual codes to IC activity terms, a single activity term enables search of all of the components of the Thomson Pharma repository.

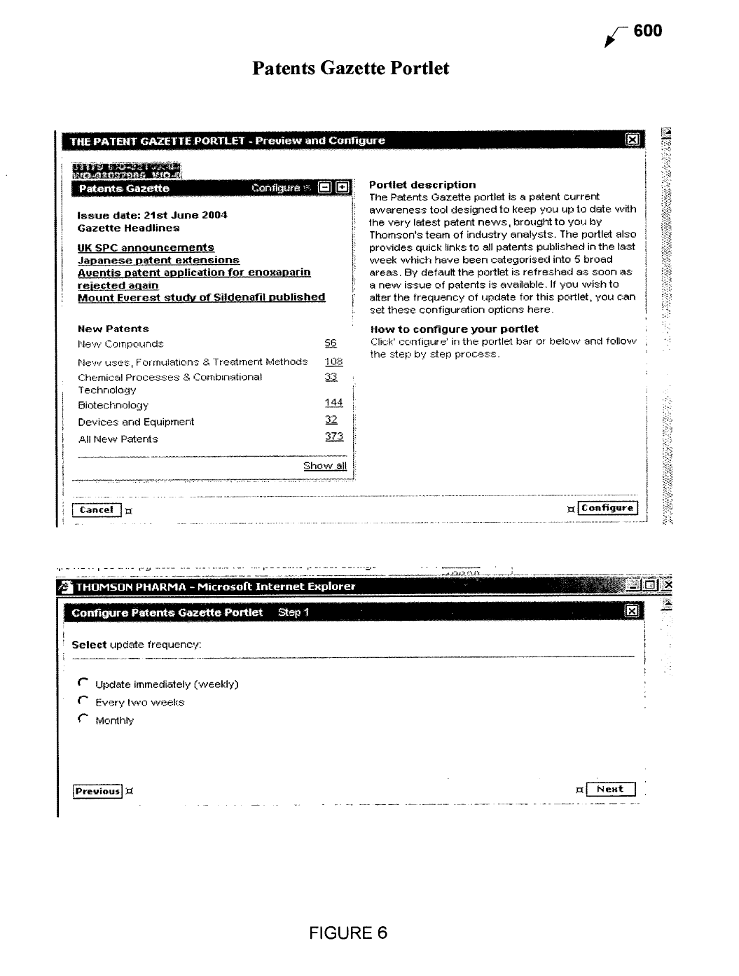

FIG. 6 shows an exemplary patents gazette portlet includes two regions: “Gazette Headlines”, and the “New patents”. The Gazette headlines are the full list of titles created when the weekly issue of Current Patents Gazette is turned into an alert for IDdb. This is the stage whereby the titles for each paragraph are created; the printed Gazette itself does not provide these titles. The New Patents are all the patents in the weekly issue of Gazette classified according to the Gazette criteria (sections A-E). Also provided is the total number of patents in the weekly issue of the Gazette. The portlet content by default is refreshed each time a new issue of CPG patent data becomes available and headlines (titles) written to create the alert on IDdb. Patents Gazette portlet configuration options include defining an update frequency and renaming the portal.

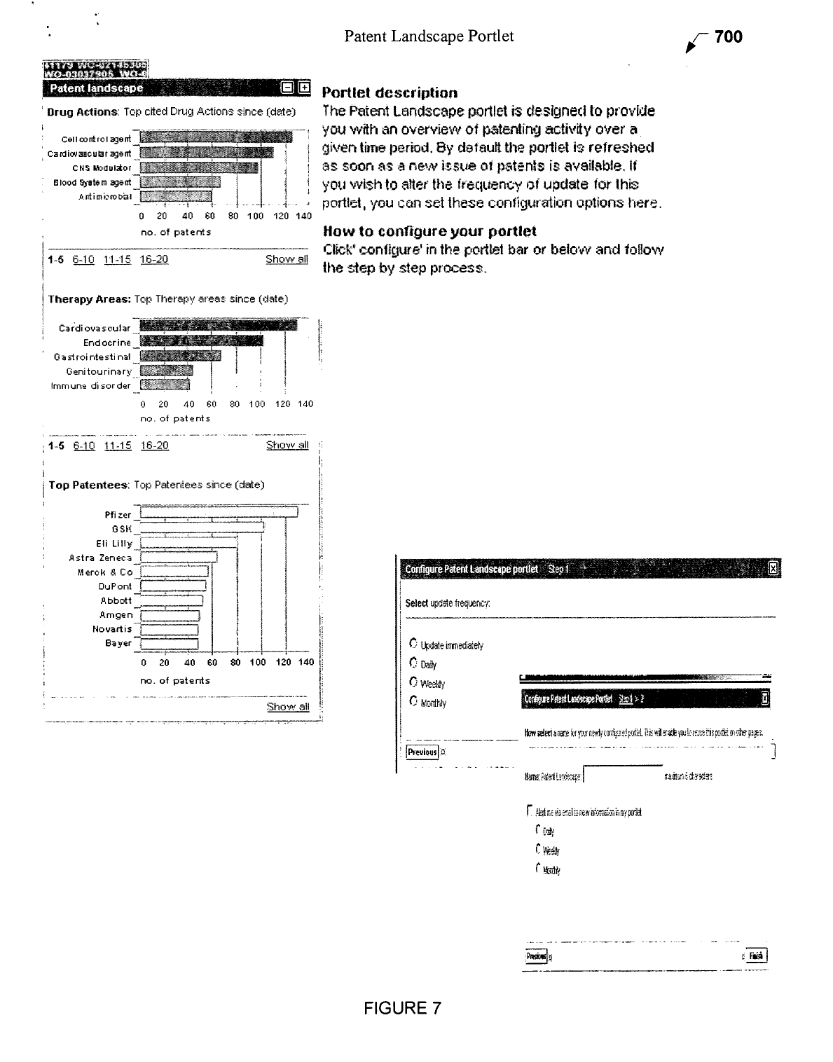

FIG. 7 shows a facsimile of an exemplary Patent Landscape portlet 700 including 3 patent landscape areas: The “Top Cited Drug Actions”, the “Top Therapy Areas” and the “Top Patentees” The Top Cited Drug Actions and Top Therapy Areas are created using the top level of the therapy area or action keyword indexing trees. If more than one indexing term has been applied to a patent, the patent is counted once in each area into which the indexing terms fall. The top patentees is based on the patent assignees on the new patents. If a patent has multiple assignees, the single patent is counted once for each assignee. The content of this portlet will not change according to therapeutic area or line of business on the specialty pages. The portlet content by default is refreshed each time a new issue of indexed patent data (PP/PFA) becomes available.

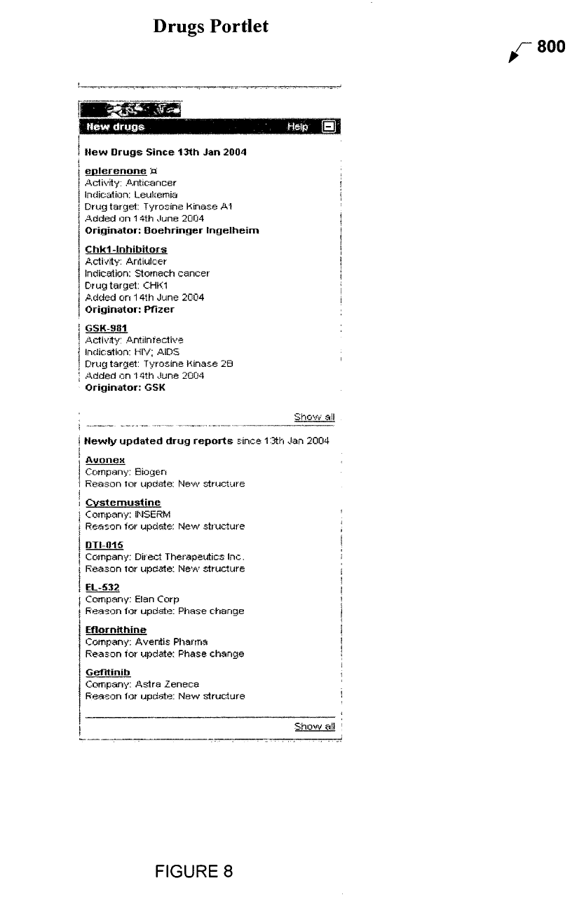

FIG. 8 shows an exemplary Drugs Portlet 800. Portlet 800 includes two sections. The first section will alert users to new drug reports. The second section will alert users to significant updates of an existing drug report (i.e. structure added or phase change). The portlet content will change according to therapeutic area selected by the user. Drugs are categorized by Editorial based on Activity using IDdb action terms and Therapeutic area using IDdb indication terms. All links from the drug names within this portlet will take users to the relevant drug report. By default, the first section of the portlet shows the first 3 results sorted alphabetically by drug name. By default the second section of the portlet shows the first 5 results as sorted alphabetically by drug name.

A number of configuration options are available for portlet 900 (as well as the other portlets). For example, the user can choose to be alerted only to new drugs of a specific structure, substructure or similarity. Alternatively, the user can choose not to limit content of this portlet by structure. The structure search functionality shown here will mirror the functionality shown on the form search pages. The user may choose to limit the portlet content to new drugs which fall within a particular therapeutic area. If a user wants to monitor two therapeutic areas in the exemplary embodiment, the user can configure two separate portlets. The user may choose to limit to new drugs which fall into a broad drug action area. If the user wished to do so, they may select a single high level activity area (top terms of action indexing trees). If a user has selected an activity area, the user will have a choice of specific actions for that particular activity area. The user can select any number of these actions or may choose not to limit to specific actions. The user may choose to limit the portlet to new drugs from a particular company or group of companies. The user can select up to 10 companies from a provided company list provided. Alternatively the user may choose not to limit by company. Another option for all portlets is to set up an e-mail alert.

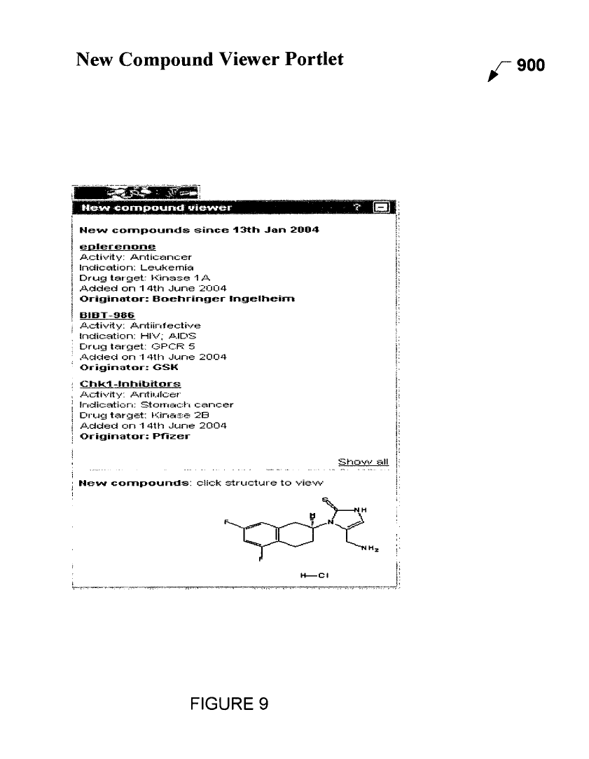

FIG. 9 shows an exemplary New Compound Viewer Portlet 900. This portlet alerts users to new compounds added to the T-Pharma compound repository. New compounds will also scroll as GIF images along the bottom part of the portlet. This portlet should display 7 days of data in a rolling weekly manner. The portlet content is derived from the original database source (e.g. IDdb/DCR/DDF/Index Chemicus) Links from the compound name and from the scrolling structures will take users to the chemistry report.

When a user hovers over a scrolling structure, the structure will stop scrolling. If the user has chosen not to limit portlet content to a particular therapy area (see left hand column of specialty pages) then by default the portlet should show the first 3 results. The priority for display is IDdb>PP/PFA>DDF>DCR>Index Chemicus. In other words if there are new compounds from all products, the first 3 compounds alphabetically from IDdb is displayed. If there are no new IDdb compounds, the first 3 DDF compounds is displayed alphabetically. (Note the alphabetical display is contrary to the screenshot.) The first 50 structures prioritized according to the same criteria as above will scroll in a continuous loop. If there are less than 50 structures, scroll all of the structures in a continuous loop. If there are no structures—state “No new compounds”.

Content of this portlet can change according to therapeutic area selected by the user. If the user has chosen to limit portlet content to a particular therapy area, the indication indexing is used to sort content.

Clicking on a structure (GIF) will also take users to a Chemistry Report (not shown). When the user hovers over a structure, the structure will stop scrolling. Structures scroll right to left. The Show All link takes users to the full list of new compound results—i.e. the List View screen containing chemistry reports (see search results specification). By default the list is sorted according to the same criteria as described for the portlet.

A link for the portlet configuration page appears at the top of the portlet when the user is in the Personalise area. The user can choose to be alerted only to new compounds of a specific structure, substructure or. Alternatively, the user can choose not to limit content of this portlet by structure. The structure search functionality shown here will mirror the functionality shown on the form search pages. The user may choose to limit the portlet content to new compounds which fall within a particular therapeutic area. Users cannot select more than one therapy area. Note this is a list of all the top terms on the indication tree and are not the list of therapy areas given on the home pages. If a user wants to monitor two therapeutic areas, the user can configure two separate portlets.

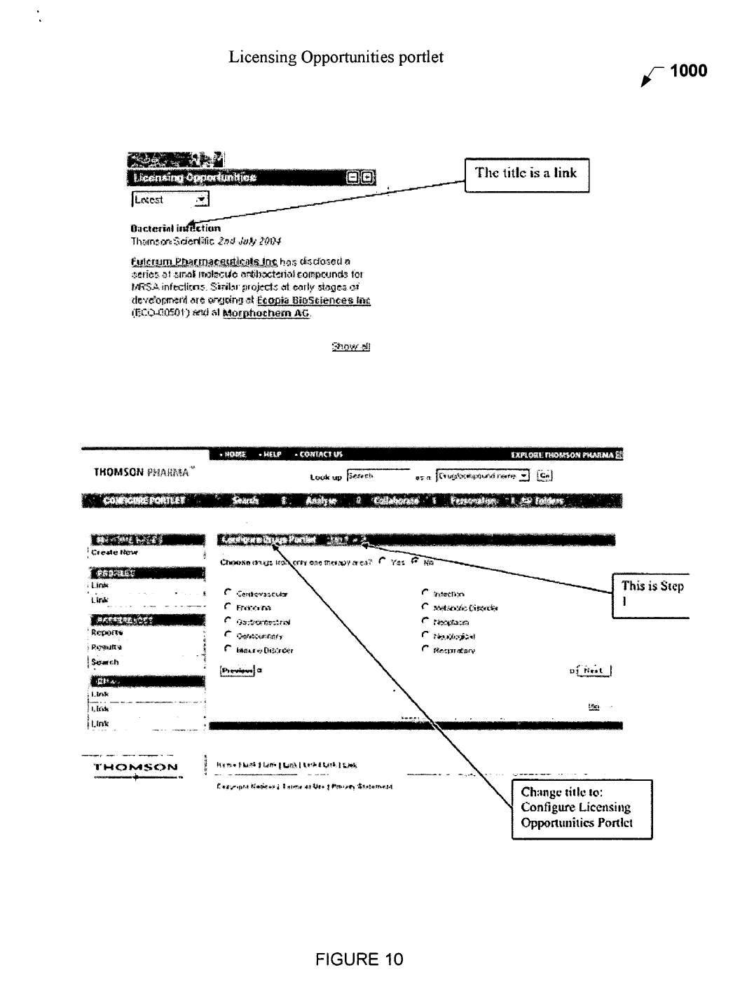

FIG. 10 shows an exemplary Licensing Opportunities portlet 1000. This portlet provides the latest Licensing Opportunity Alert (s) (selected by Topic ‘Licensing Opportunity’) with the option to view the last ‘5-days’ one day at a time via a menu. If there are no new alerts, this portal displays the message ‘There are no Licensing Opportunities items for this date’ If there is more than one alert published on one day, all the Alerts are displayed in the portlet. This portal can be filtered by the ‘Therapy Area’ categories, like other portlets.

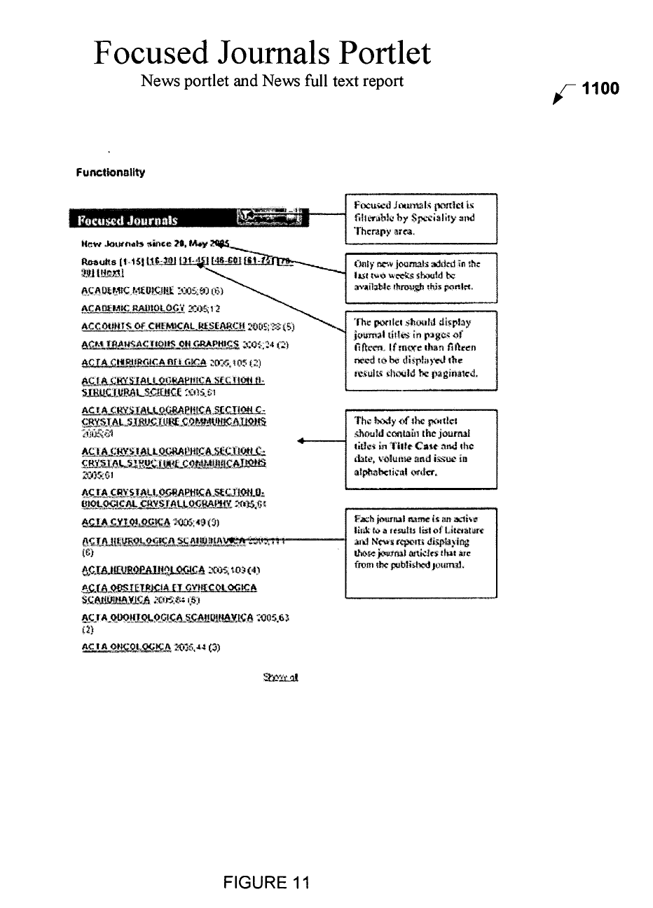

FIG. 11 shows an exemplary focused journals portlet 1100, which display newly published journals on a biweekly basis that are of interest to a particular speciality. In the exemplary embodiment, the speciality home pages including the focused journal portlet are Biology, Chemistry, Clinical Research, General Interest, plus any user-defined home pages. The focused journals portlet is configurable so that the user can select up to 60 journals that they wish to be alerted when new articles are added to the database. The user is able to select from all available journals (approx. 3,500) and also select a timeframe to monitor new additions from 2 weeks to 8 weeks. The user can also configure this portlet to provide update frequencies of 2, 4 and 8 weeks.

### Exemplary Methods of Operation

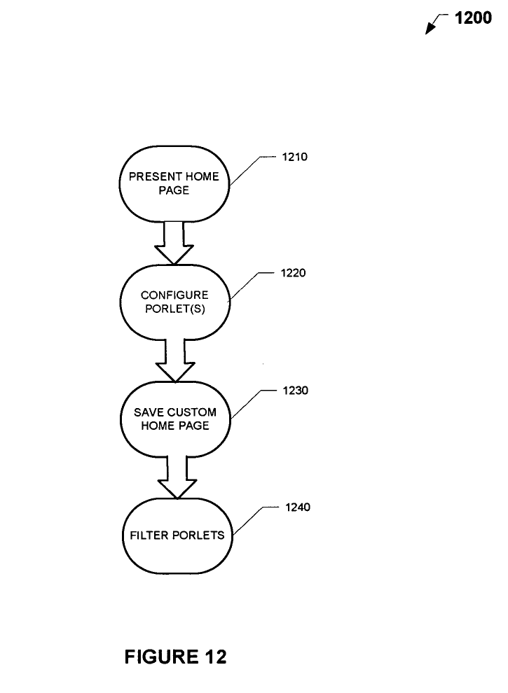

FIG. 12 shows a flow chart 1200 of one or more exemplary methods of operating system 100. Flow chart 1200 includes blocks 1210-1240, which are arranged and described in a serial sequence in the exemplary embodiment. However, other embodiments execute two or more blocks in parallel using multiple processors or processor-like devices or a single processor organized as two or more virtual machines or sub processors. Other embodiments also alter the process sequence or provide different functional partitions to achieve analogous results. Moreover, still other embodiments implement the blocks as two or more interconnected hardware modules with related control and data signals communicated between and through the modules. Thus, the exemplary process flow applies to software, hardware, and firmware implementations.

Block 1210 entails presenting a pharmaceutical research homepage. In the exemplary embodiment, this entails a user directing a browser of an access device, such as device 130, to server 120 and then logging onto the system. Successful login results in one or more portions of a web-based interface, such as home page 139 which includes two or more portlets, being output from server 120, stored in memory 112, and displayed by access device 130.

Block 1220 entail configuring one or more of the portlets. In the exemplary embodiment, this entails changing an update frequency parameter or target company list or other indexed parameter associated with data in the one or more portlets.

Block 1230 entails saving the home page with the just configured portlets. In the exemplary embodiment, this entails updating the subscriber information for the use with the configuration data indicative of the change made in block 1220

Block 1240 entails filtering data in two of more of the portlets of the home page. In the exemplary embodiment, this entails the user selecting one or more therapeutic parameters, such as categories, associated with the data in two or more portlets and modifying the displayed data to exclude data not matching the therapeutic parameters. In some embodiments, the selection may be used to exclude data that matches the selected parameters.

### CONCLUSION

The embodiments described above are intended only to illustrate and teach one or more ways of making and using the present invention, not to restrict its breadth or scope. The actual scope of the invention, which embraces all ways of practicing or implementing the teachings of the invention, is defined only by one or more issued patent claims and their equivalents.

What is claimed is:

1. An online pharmaceutical research system comprising:
a set of two or more databases including a patent database, a scientific literature database; and a financial information database; and
a server operarably couplable to the databases and to first and second client access devices via a computer network, wherein the first and second client access devices are associated respectively with first and second users and the server is configured to provide first and second home pages to the first and second client access devices, wherein each of the home pages includes at least first and second portlets, with the first portlet configured to receive and present information from one of the patent, scientific literature, and financial information databases, and the second portlet another of the patent, scientific literature, and financial databases.

2. The system of claim 1, wherein the server is operatively associated with a subscriber database including first and second preferences for the respective first and second users, and the first and second home pages are configured respectively according to the first and second preferences.

3. The system of claim 1, wherein the server is configured to provide a plurality of home pages for each of the first and second users.

4. The system of claim 1, further comprising a subscriber database associated with the server, wherein the subscriber database includes first and second records for the first and second users, with each record logically associating its corresponding user with a plurality of home page identifiers, and each of the home page identifiers is logically associated with a plurality of portlet identifiers or portlet configurations.

5. A method comprising:
presenting a home page having a plurality of pharmaceutically related portlets;
receiving input from a user identifying a therapeutic category; and
in response to the identified therapeutic category modifying contents of two or more of the pharmaceutically related portlets.

6. The method of claim 5, wherein one of the portlets includes patent data and another of the portlets includes financial data.
